(19) United States
(12) Patent Application Publication
(10) Pub. No.: US 2025/0285344 A1
(43) Pub. Date: Sep. 11, 2025

(54) MODIFYING IMAGES FOR IMPROVED SEARCH

(71) Applicant: Etsy, Inc., Brooklyn, NY (US)

(72) Inventors: Karl Groethe, Brooklyn, NY (US); Sachin Malhotra, Brooklyn, NY (US); Karl Ni, Brooklyn, NY (US); Luis Lara, Brooklyn, NY (US); Eve Ahearn, Brooklyn, NY (US)

(21) Appl. No.: 18/601,325

(22) Filed: Mar. 11, 2024

(51) Int. Cl. G06T 11/60

(52) U.S. Cl. CPC G06T 11/60

(57) ABSTRACT

Methods, systems, and apparatus, including computer programs encoded on computer storage media, for modifying images for improved search. One of the methods includes generating a first embedding that represents an input image using a first encoder, wherein a dimension of the first embedding matches a first dimension; generating, using the first embedding, a second embedding that represents (i) the input image and (ii) a modification to the input image, wherein a dimension of the second embedding matches the first dimension; generating, using the second embedding, a third embedding that represents (i) the input image and (ii) the modification to the input image using a second encoder; and identifying, using the third embedding, a set of one or more images that are different from the input image.

### TECHNICAL FIELD

This specification relates to electronic searching.

### BACKGROUND

Items stored electronically can be searched, e.g., in a database of items. A user can provide relevant search queries and be provided data relating to those queries.

### SUMMARY

This specification describes technologies for improving searching using image modification. These technologies generally involve generating image embeddings and then modifying an image embedding to generate an augmented embedding. The augmented embedding can represent a modification (e.g., specified by a user) from an original image or other data—e.g., to home in on a particular type of feature for finding an item. The augmented embedding can then be compressed to generate an index embedding to enable optimization of search functionality. The index embedding can be used to find items similar to the item for which modification was specified.

In general, one innovative aspect of the subject matter described in this specification can be embodied in methods that include the actions of generating a first embedding that represents an input image using a first encoder, wherein a dimension of the first embedding matches a first dimension; generating, using the first embedding, a second embedding that represents (i) the input image and (ii) a modification to the input image, wherein a dimension of the second embedding matches the first dimension; generating, using the second embedding, a third embedding that represents (i) the input image and (ii) the modification to the input image using a second encoder; and identifying, using the third embedding, a set of one or more images that are different from the input image. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination. In some implementations, the modification input is text provided by a user of an input device. In some implementations, the input image represents a product or service listing on an e-commerce platform. In some implementations, identifying the set of one or more images that are different from the input image includes: identifying product listings, where each of the set of one or more images represents one or more of the product listings. In some implementations, the first encoder and the second encoder are autoencoders.

In some implementations, identifying the set of one or more images that are different from the input image includes: performing one or more operations of an approximate nearest neighbor (ANN) algorithm. In some implementations, prior to performing the one or more operations of the ANN algorithm, actions include: generating, using the second encoder, one or more embeddings of a same dimension as the third embedding; and performing, using the one or more embeddings of the same dimension as the third embedding and the third embedding, the one or more operations of the ANN algorithm.

In some implementations, generating the third embedding that represents (i) the input image and (ii) the modification to the input image includes: compressing the second embedding from the first dimension to a second dimension. In some implementations, the first dimension includes 16,000 values and the second dimension includes 512 values.

In some implementations, generating the first embedding that represents the input image includes: generating an initial embedding using the first encoder; and generating a diffused embedding as the first embedding using a diffusion model. In some implementations, generating the first embedding occurs in batch prior to generating the second embedding. In some implementations, generating the second embedding includes: providing (i) the first embedding and (ii) the modification to the input image to a reverse diffusion model, wherein the reverse diffusion model generates the second embedding. In some implementations, the reverse diffusion model includes U-Net architecture.

In general, another innovative aspect of the subject matter described in this specification can be embodied in methods that include the actions of generating a first embedding that represents an input image using a first encoder, wherein a dimension of the first embedding matches a first dimension; generating, using the first embedding, a second embedding that represents the input image using a second encoder, wherein a dimension of the second embedding is less than the first dimension; generating, using the second embedding, a third embedding that represents the input image using a first decoder, wherein a dimension of the third embedding matches the first dimension; and generating, using the third embedding, a reconstructed version of the input image. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination. In some implementations, actions include adjusting one or more of the first encoder, second encoder, or the first decoder using a value representing difference between the reconstructed version of the input image and the input image.

In general, a third aspect of the subject matter described in this specification can be embodied in methods that include the actions of generating a first embedding that represents an input image using a first encoder; generating, using the first embedding and a diffusion model, a diffused version of the first embedding; identifying, using the diffused version of the first embedding and a classifier model, a predicted type of diffusion represented by the diffused version of the first embedding; and updating, using the predicted type of diffusion, the classifier model. Other embodiments of this aspect include corresponding computer systems, apparatus, and computer programs recorded on one or more computer storage devices, each configured to perform the actions of the methods.

The technology described in this specification can be implemented so as to realize one or more of the following advantages. For example, a processing system can optimize use of different embeddings to improve accuracy, energy efficiency, and speed. A first, larger embedding, can be used to generate an augmented version of an image. A second, compressed embedding can be used for searching for items similar to the larger embedding used for augmentation. By using both the first embedding and second embedding, the processing system can improve accuracy, energy efficiency, and speed, e.g., of search.

By allowing user modification input, techniques described also improve a user experience by allowing a user to jump from a current item to one that is similar in a particular way described by the modification input. In this way, items can be found more easily and more efficiently. Also, techniques described allow users to specify items that might not yet exist in a current set but could be created, e.g., by sellers or added at some point in the future.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example search improvement environment.

FIG. 2 is a training system.

FIG. 3 is a flowchart of an example process for improving search.

FIG. 4 is a flowchart of an example process for training encoders and decoders.

FIG. 5 is a flowchart of an example process for training classifier models.

Like reference numbers and designations in the various drawings indicate like elements.

### DETAILED DESCRIPTION

Techniques described can improve searching for items in a stored set. Techniques can include using a first item of the set and modification input to identify items similar to the first item but different according to the modification input.

For example, a user can identify a first item using an initial search or by browsing a number of items. The first item might be a clock—e.g., an online listing of a clock for sale represented by an image. Modification input can be, e.g., “This, but in red.” Systems described can then provide a list of similar items to the first item but that have one or more features that are red. Modifications can include shape, color, among other features.

To extend the clock example, if searching for “clocks”, e.g., on an online e-commerce platform, the search results can include images of clocks with various features. The search results might include items that are close, but not quite, what a user is looking for. Using techniques described in this specification, a user can identify one or more items in the search results, or identified in another way, and provide modification input to generate items similar to the identified one or more items but modified according to the modification input.

In one example case, a user searches for clocks with a particular numbering format on the clock face. Search results might include a brown clock with the particular numbering format but that are the wrong color. The user can identify the brown clock item and include modification input, such as “Show me something that looks like this, but in red.” Systems described in this specification can then identify items that are similar to the brown clock but that are red. In general, the improved search results after modification can include one or more features in common with the one or more identified items—e.g., of an initial search or browsing—and one or more features described in the modification input. Modification input can include any type of modification—e.g., shape, color, location, age, variety, or a combination of one or more of these. Modification input can be freeform text. In some cases, modification input is not limited in any way, shape, or form. For example, modification can be limited by a classification process used, where a given classifier or embedding can be used to process various types of modifications.

In some implementations, techniques described can help users identify items that differ from what is included in search results or from an item navigated to through browsing or other means.

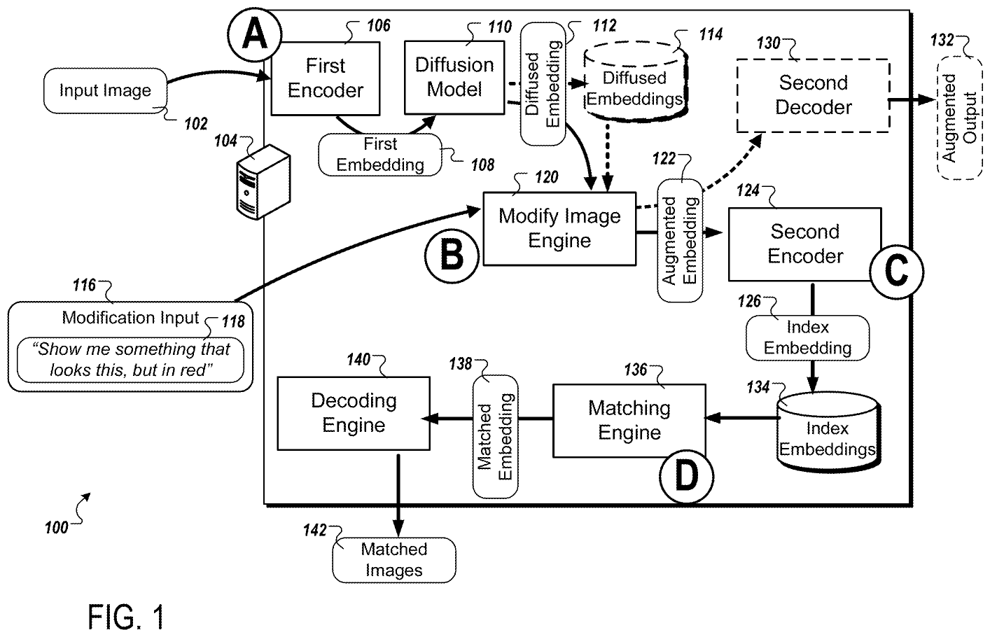

FIG. 1 shows an example search improvement environment 100. The environment 100 includes a processing system 104. The processing system 104 includes a number of elements, including a first encoder 106, a diffusion model 110, a diffused embeddings data storage 114, a modify image engine 120, a second encoder 124, a first decoder 130, an index embeddings data storage 134, a matching engine 136, and a decoding engine 140. The processing system 104 can include one or more computers, e.g., communicably connected to one another. The processing system 104 can include one or more processors configured to perform operations of the number of elements.

In general, FIG. 1 shows an improved search where the processing system 104 generates a set of matched images 142 using an input image 102 and modification input 116. The matched images 142 are similar to the input image 102 but are different. Differences between the matched images 142 and the input image 102 are described in the modification input 116. In this example scenario, the modification input 116 is textual and includes “Show me something that looks like this, but in red.” The matched images 142 can, thus, include features similar to the input image 102 but with one or more elements in the color red.

In stage A, the processing system 104 obtains the input image 102. The input image 102 can be any type of image. In some cases, the input image 102 represents a listing—e.g., included in an online e-commerce platform. For example, the listing can be for a product for sale on a website. The images can represent products for sale and be used to aid a user in selecting an item for purchase.

The first encoder 106 of the processing system 104 obtains the input image 102. The first encoder 106 generates a first embedding 108. The first embedding 108 can include a number of values—e.g., 16,000—that represent the input image 102. In some implementations, the first encoder 106 is a variational autoencoder. For example, the first encoder 106 can be trained to generate an embedding with a given dimension—e.g., 16,000, among other values—that represents the input image 102.

The diffusion model 110 obtains the first embedding 108 and generates a diffused embedding 112. In some implementations, the diffusion model 110 adds noise to the first embedding 108 to generate the diffused embedding 112. For example, the diffusion model 110 can add different type of noise—e.g., one or more of Gaussian, Gamma, or Poisson noise. Adding noise can include adjusting one or more values of the first embedding 108 to generate one or more values of the diffused embedding 112.

The processing system 104 can optionally store the diffused embedding 112 in the diffused embeddings data storage 114. The processing system 104 can generate diffused embeddings for one or more other images and store the resulting diffused embeddings in the diffused embeddings data storage 114. In some implementations, the processing system 104 generates one or more diffused embeddings using batch processing. For example, the processing system 104 can process multiple images, e.g., as a single group, to generate a set of diffused embeddings. The processing system 104 can store the set of diffused embeddings in the diffused embeddings data storage 114 to later be used in improving search.

In stage B, the modify image engine 120 obtains the modification input 116 and the diffused embedding 112 to generate an augmented embedding 122. The modification input 116 includes textual data 118 that includes “Show me something that looks this, but in red.” Input can be provided by a user, e.g., using any number of input/output devices, such as computers or smartphones.

In some cases, other modification input or types of modification input can be used. Modification input can be represented using audio data, image data, sensor data, among other types of data. The modification input can represent a modification of the input image 102. In some implementations, non-textual input is converted to text by the processing system before being used as modification input. For example, one or more models can be trained to convert non-textual input into text input to be used as modification input.

In some implementations, the modify image engine 120 includes a transformation deep neural network (DNN). In some implementations, the modify image engine 120 includes U-Net architecture. For example, the modify image engine 120 can include U-Net architecture combined with a diffusion process to generate the augmented embedding 122.

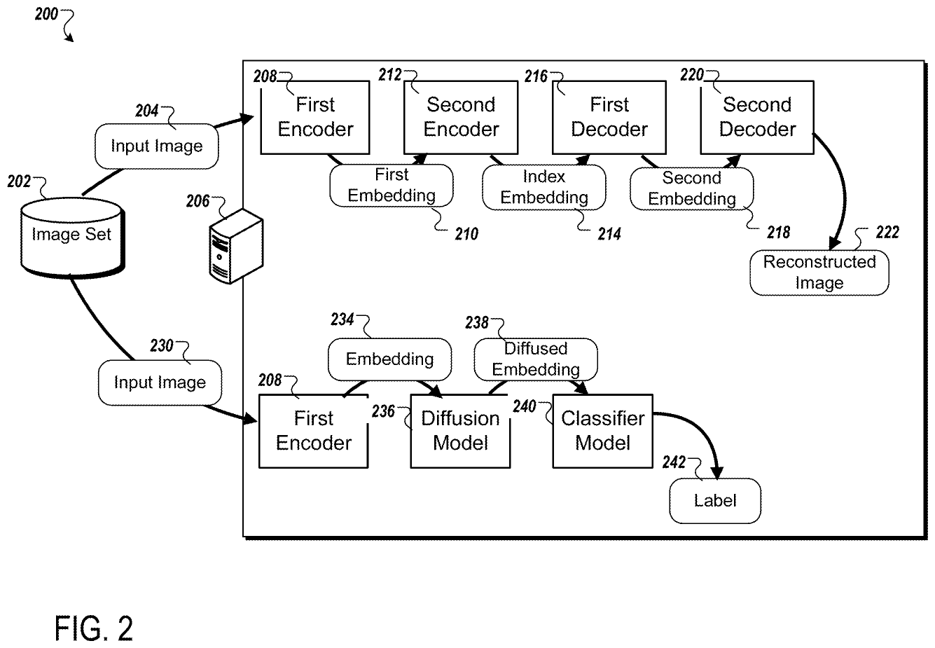

In some implementations, the modify image engine 120 modifies the diffused embedding 112 according to the modification input 116. For example, the modify image engine 120 can perform reverse or forward diffusion to further adjust the diffused embedding 112 such that the diffused embedding 112 represents features described by the modification input 116. How to modify the diffused embedding 112 using the modification input 116 can be learned in a machine learning process—e.g., discussed in FIG. 2. A model trained to modify images can be included in the modify image engine 120.

The modify image engine 120 can optionally provide the augmented embedding 122 to the first decoder 130. In some implementations, the first decoder 130 generates an augmented output 132. For example, the first decoder 130 generate the augmented output 132 as an image that represents the augmented embedding 122. An image of the augmented output 132 can represent features similar to the input image 102 but with differences, such as differences described in the modification input 116. The augmented output 132 can be used, in some cases, to provide to a user to allow the user to see what has been generated using their modification input.

In stage C, the second encoder 124 obtains the augmented embedding 122 and generates an index embedding 126. The index embedding 126 can be similar to the first embedding 108 in that they both represent an image. However, in some cases, the index embedding 126 is represented in a smaller dimension compared to the first embedding 108—e.g., to reduce computation or energy usage or to increase speed.

The second encoder 124 can optionally store the index embedding 126 in the index embeddings data storage 134. Similar to the storage in the diffused embeddings data storage 114, the index embeddings data storage 134 can then be used by subsequent processes to obtain index embeddings. The second encoder 124 can provide the index embedding 126 to the matching engine 136. The matching engine 136 can obtain the index embedding 126 from the index embeddings data storage 134.

In some implementations, the second encoder 124 includes an autoencoder, such as a variational autoencoder. The autoencoder can be trained to generate an embedding of a first dimension from an embedding of a second dimension where the first dimension is smaller than the second dimension. An example training process is shown in FIG. 2.

The processing system 104 can optimize the use of different embeddings to improve accuracy, energy efficiency, and speed. The diffused embedding 112 and the augmented embedding 122 represent embeddings used to capture the modifications described in the modification input 116. The index embedding 126 is used for matching to similar images. Thus, the processing system 104 can use a larger number of values for the diffused embedding 112 and the augmented embedding 122 compared to the index embedding 126. Using larger embeddings can improve an accuracy of an augmented embedding—e.g., accurately modifying the diffused embedding to represent features described in the modification input—but using such larger embeddings for searching can be processor and energy intensive. By using larger embeddings for augmentation and smaller embeddings for subsequent matching, the processing system 104 can improve accuracy of the generated augmented embedding, relative to the description provided in the modification input 116, while reducing the power and energy uses in the subsequent searching using the index embedding 126 that is reduced in size—e.g., reduced from 16,000 values to 512 values.

In stage D, the matching engine 136 obtains the index embedding 126 and generates a matched embedding 138. In some implementations, the matching engine 136 performs an approximate nearest neighbor (ANN) algorithm. For example, the matching engine 136 can determine one or more similar images similar to the index embedding 126. The matching engine 136 can obtain one or more other indexes in the index embeddings data storage 134 to compare with the index embedding 126 to determine one or more similar indexes representing images. Particular ANN algorithms can include Flat, locality-sensitive hashing (LSH), hierarchical navigable small world (HNSW), or inverted file (IVF).

The decoding engine 140 can generate one or more of the matched images 142 using the matched embedding 138. The decoding engine 140 can include a trained autoencoder configured to convert from an embedding space of the matched embedding 138 to an image. In some implementations, the matched embedding 138 is of a same dimension as the index embedding 126. For example, the dimension can be 512. The decoding engine 140 can include one or more autoencoders to convert, from the embedding space of the matched embedding 138, to a visual image.

In some implementations, the index embeddings data storage 134 includes indexes for online product listings. For example, each index in the index embeddings data storage 134 can include an embedding for an image that represents a product listing. By using the matching engine 136 to identify similar index embeddings in the index embeddings data storage 134 compared to the index embedding 126, the processing system 104 can generate a list of similar listings and provide an indication of that list to a user—e.g., using a graphical user interface.

In some implementations, embeddings of the diffused embeddings data storage 114 are generated in batch. For example, embeddings of the diffused embeddings data storage 114 can be generated offline prior to obtaining the modification input 116. That way, a response time for responding to the modification input 116 with, e.g., the matched images 142, can be reduced. In some implementations, the modification of one or more diffused embeddings using a modification input is performed online. For example, the processing system 104 can include one or more computer servers that process data sent over a network. The processing system 104 can process data received over a network—e.g., in stages B through D—using one or more computers and then provide feedback, e.g., to a user terminal used to provide the modification input 116.

FIG. 2 shows a training system 200. The training system includes a processing system 206. The processing system 206 can be the same as the processing system 104 or different than the processing system 104. The processing system 104 can perform operations described in regard to FIG. 2.

To train a first encoder 208, second encoder 212, first decoder 216, and second decoder 220, the processing system 206 can obtain input image 204 and generate a reconstructed image 222. Each of the encoders and decoders can generate or obtain an embedding in a sequence that ends with the second decoder 220 using a second embedding 218, generated by the first decoder 216, to generate the reconstructed image 222.

In some implementations, the processing system 206 uses a comparison of the reconstructed image 222 and the input image 204 to adjust one or more values in one or more models included in the first encoder 208, the second encoder 212, the first decoder 216, or the second decoder 220.

In some implementations, the first encoder 208 is used in the processing system 104 to generate the first embedding 108. In some implementations, the second encoder 212 is used in the processing system 104 to generate the index embedding 126. In some implementations, the decoding engine 140 includes both the first decoder 216 and the second decoder 220—e.g., to reconstruct an image using an embedding. In some implementations, the second decoder 220 is used in the processing system 104 to generate the augmented output 132.

In some implementations, one or more of the encoders or decoders of the training system 200 are autoencoders, such as variation autoencoders, denoising autoencoder (DAE), sparse autoencoder (SAE), or contractive autoencoder (CAE).

In some implementations, the first embedding 210 is of a dimension greater than the index embedding 214. For example, the first embedding 210 can be 16,000 values and the index embedding 214 can be 512. In some implementations, the second embedding 218 matches the dimension of the first embedding 210.

To train a diffusion model 236 and a classifier model 240, the processing system 206 can obtain an input image 230 and generate a label 242. In some cases, the training process includes determining how to reconstruct denoised images after introducing noise, e.g., in small steps. The training can be guided toward a particular outcome with an associated classifier—e.g., that can be trained to classify in the presence of noise. By including error in a given classification with a denoising error, the processing system 206 can reconstruct images that both remove noise and move closer to a target classification.

The first encoder 208 generates an embedding 234. The diffusion model 236 obtains the embedding 234 and generates a diffused embedding 238. The diffusion model 236 can be used in the processing system 104 to generate the diffused embedding 112. The diffusion model 236 can generate noise in embeddings generated by the first encoder 208. The noise can represent various changes or modifications to the input image 230 represented by the embedding 234. For example, modifications can include changes in color, shape, or other feature.

The classifier model 240 obtains the diffused embedding 238 and generates the label 242. The classifier model 240 can be adjusted, e.g., by the processing system 206 to correctly identify adjustments made in the diffused embedding 238.

In some implementations, the classifier model 240 includes a contrastive language-image pre-training (CLIP) model. For example, the classifier model 240 can, generally, direct how reconstruction occurs from the diffused embedding generated by the diffusion model 236. In some implementations, the classifier model 240 predicts the alteration done on an image by the diffusion model 236. In general, the diffusion model 236 can remove noise from an image so that it fits modification input, such as a prompt. The process can include adding noise to an image, such as the input image 230, but not so much that an original context is lost. The process can include removing added noise but doing so guided by modification input, such as a textual prompt, so that a new image aligns with the input. In general, the diffusion model 236 can denoise an image such that the denoise output, e.g., the diffused embedding 238, encodes to something that represents features described in modification input.

For example, noise can be added such that the diffused embedding 238 represents one or more specific modifications compared to the embedding 234. The classifier model 240 can then label the modification—e.g., feature A changed in shape or feature A changed in color. In general, the classifier model 240 can determine changes using structural components rather than a pixel-by-pixel determination. In some implementations, the classifier model 240 identifies wider structural aspects captured by embeddings compared to a pixel-by-pixel comparison. For example, the classifier model 240 can generate a direction—e.g., error deltas—between a target and an existing noisy image. In an example case, a color classifier can identify an element of an image classified as “red” at 0.4 likelihood compared to green at 0.6 likelihood. In adjusting one or more weights or parameters of the classifier model 240, the processing system 206 can adjust values such that a subsequent generated version of the element is classified with “red” at 0.9 likelihood when “red” is included as a feature represented by modification input, such as the modification input 116.

In some implementations, the processing system 206 uses the label 242 to adjust the classifier model 240. For example, the processing system 206 can compare known modifications with the label 242 to determine if the classifier model 240 correctly classified one or more given modifications generated from the input image 230.

In some implementations, one or more of the classifier model 240 or the diffusion model 236 is used in the processing system 104 to generate the augmented embedding 122. For example, using the modification input 116, the classifier model 240 can generate the augmented embedding 122.

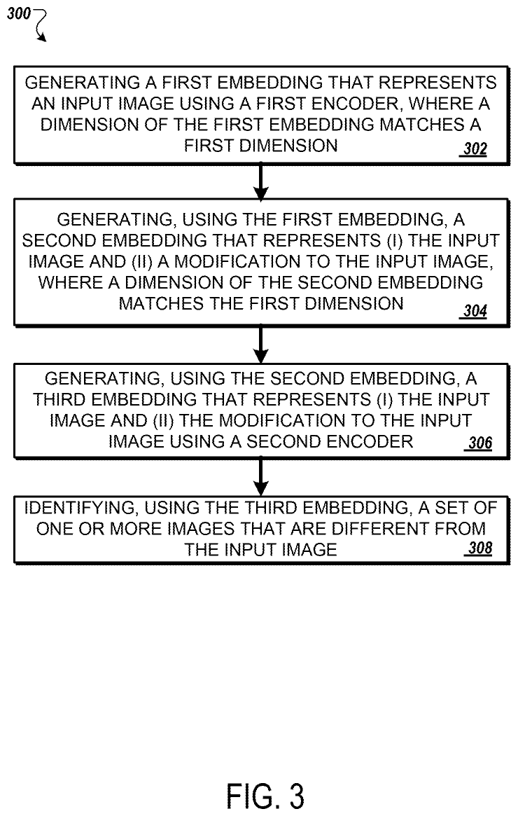

FIG. 3 is a flowchart of an example process 300 for improving search. For convenience, the process 300 will be described as being performed by a system of one or more computers, located in one or more locations, and programmed appropriately in accordance with this specification. For example, a processing system, e.g., the processing system 104 of FIG. 1, appropriately programmed, can perform the process 300.

The process 300 includes generating a first embedding that represents an input image using a first encoder, where a dimension of the first embedding matches a first dimension (302). For example, the first encoder 106 can generate the first embedding 108 or the diffusion model 110 can generate the diffused embedding 112 as a first embedding with a first dimension.

The process 300 includes generating, using the first embedding, a second embedding that represents (i) the input image and (ii) a modification to the input image, where a dimension of the second embedding matches the first dimension (304). For example, the modify image engine 120 can generate the augmented embedding 122 using one or more diffused embeddings, e.g., from the diffused embeddings 114.

The process 300 includes generating, using the second embedding, a third embedding that represents (i) the input image and (ii) the modification to the input image using a second encoder (306). For example, the second encoder 124 can generate the index embedding 126.

The process 300 includes identifying, using the third embedding, a set of one or more images that are different from the input image (308). For example, the matching engine 136 can determine one or more matched embeddings, e.g., the matched embedding 138, using the index embedding 126.

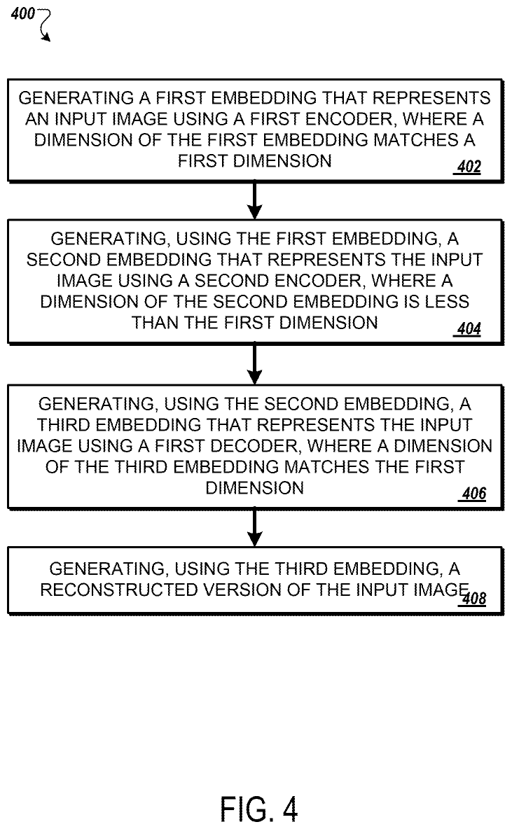

FIG. 4 is a flowchart of an example process 400 for training encoders and decoders. For convenience, the process 400 will be described as being performed by a system of one or more computers, located in one or more locations, and programmed appropriately in accordance with this specification. For example, a processing system, e.g., the training system 200 of FIG. 2, appropriately programmed, can perform the process 400.

The process 400 includes generating a first embedding that represents an input image using a first encoder, where a dimension of the first embedding matches a first dimension (402). For example, the first encoder 208 can generate the first embedding 210 using the input image 204.

The process 400 includes generating, using the first embedding, a second embedding that represents the input image using a second encoder, where a dimension of the second embedding is less than the first dimension (404). For example, the second encoder 212 can generate the index embedding 214.

The process 400 includes generating, using the second embedding, a third embedding that represents the input image using a first decoder, where a dimension of the third embedding matches the first dimension (406). For example, the first decoder 216 can generate the second embedding 218.

The process 400 includes generating, using the third embedding, a reconstructed version of the input image (408). For example, the second decoder 220 can generate the reconstructed image 222.

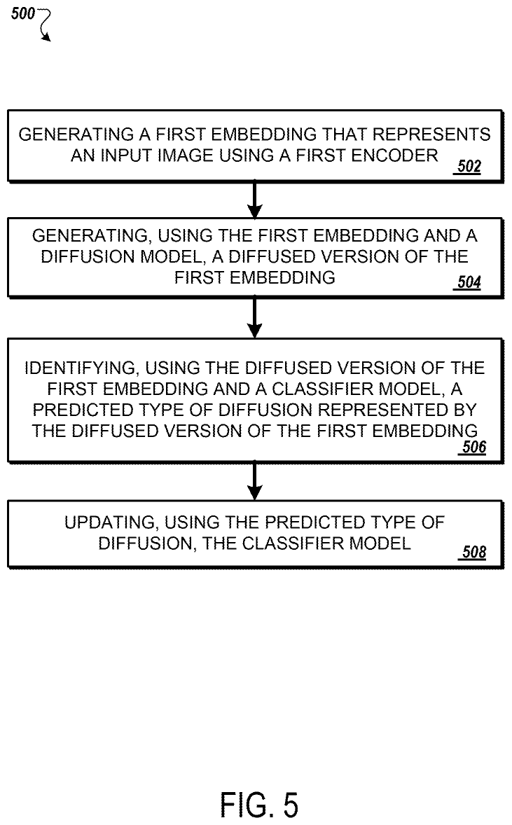

FIG. 5 is a flowchart of an example process 500 for training classifier models. For convenience, the process 500 will be described as being performed by a system of one or more computers, located in one or more locations, and programmed appropriately in accordance with this specification. For example, a processing system, e.g., the training system 200 of FIG. 2, appropriately programmed, can perform the process 500.

The process 500 includes generating a first embedding that represents an input image using a first encoder (502). For example, the first encoder 208 can generate the embedding 234 using the input image 230.

The process 500 includes generating, using the first embedding and a diffusion model, a diffused version of the first embedding (504). For example, the diffusion model 236 can generate the diffused embedding 238 using the embedding 234.

The process 500 includes identifying, using the diffused version of the first embedding and a classifier model, a predicted type of diffusion represented by the diffused version of the first embedding (506). For example, the classifier model 240 can generate the label 242, e.g., that indicates a predicted type of diffusion.

The process 500 includes updating, using the predicted type of diffusion, the classifier model (508). For example, the processing system 206 can update elements of the training system 200, e.g., the classifier model 240.

In some implementations, a forward diffusion model adds noise in a series of steps. For example, the diffusion model 236 can add noise to the input image 230 using the embedding 234 in a series of one or more steps where each step adds a level of noise.

In this specification the term “engine” refers broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

In this specification, the term “database” is used broadly to refer to any collection of data: the data does not need to be structured in any particular way, or structured at all, and it can be stored on storage devices in one or more locations.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, subprograms, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magnetooptical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech, or tactile feedback or responses; and input from the user can be received in any form, including acoustic, speech, tactile, or eye tracking input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

The subject matter described in this specification can be implemented in a computing system that includes a backend component, e.g., as a data server, or that includes a middleware component, e.g., an application server, or that includes a frontend component, e.g., a client computer having a graphical user interface, a web browser, or an app through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
generating a first embedding that represents an input image using a first encoder, wherein a dimension of the first embedding matches a first dimension;
generating, using the first embedding, a second embedding that represents (i) the input image and (ii) a modification to the input image, wherein a dimension of the second embedding matches the first dimension;
generating, using the second embedding, a third embedding that represents (i) the input image and (ii) the modification to the input image using a second encoder; and
identifying, using the third embedding, a set of one or more images that are different from the input image.

2. The method of claim 1, wherein the modification input is text provided by a user of an input device.

3. The method of claim 1, wherein the input image represents a product or service listing on an e-commerce platform.

4. The method of claim 1, wherein identifying the set of one or more images that are different from the input image comprises:
identifying product listings, wherein each of the set of one or more images represents one or more of the product listings.

5. The method of claim 1, wherein the first encoder and the second encoder are autoencoders.

6. The method of claim 1, wherein identifying the set of one or more images that are different from the input image comprises:
performing one or more operations of an approximate nearest neighbor (ANN) algorithm.

7. The method of claim 6, wherein, prior to performing the one or more operations of the ANN algorithm, the method comprises:
generating, using the second encoder, one or more embeddings of a same dimension as the third embedding; and
performing, using the one or more embeddings of the same dimension as the third embedding and the third embedding, the one or more operations of the ANN algorithm.

8. The method of claim 1, wherein generating the third embedding that represents (i) the input image and (ii) the modification to the input image comprises:
compressing the second embedding from the first dimension to a second dimension.

9. The method of claim 8, wherein the first dimension includes 16,000 values and the second dimension includes 512 values.

10. The method of claim 1, wherein generating the first embedding that represents the input image comprises:
generating an initial embedding using the first encoder; and
generating a diffused embedding as the first embedding using a diffusion model.

11. The method of claim 10, wherein generating the first embedding occurs in batch prior to generating the second embedding.

12. The method of claim 1, wherein generating the second embedding comprises:
providing (i) the first embedding and (ii) the modification to the input image to a reverse diffusion model, wherein the reverse diffusion model generates the second embedding.

13. The method of claim 12, wherein the reverse diffusion model includes U-Net architecture.

14. A system comprising one or more computers and one or more storage devices on which are stored instructions that are operable, when executed by the one or more computers, to cause the one or more computers to perform operations comprising:
generating a first embedding that represents an input image using a first encoder, wherein a dimension of the first embedding matches a first dimension;
generating, using the first embedding, a second embedding that represents (i) the input image and (ii) a modification to the input image, wherein a dimension of the second embedding matches the first dimension;
generating, using the second embedding, a third embedding that represents (i) the input image and (ii) the modification to the input image using a second encoder; and
identifying, using the third embedding, a set of one or more images that are different from the input image.

15. The system of claim 14, wherein the modification input is text provided by a user of an input device.

16. The system of claim 14, wherein the input image represents a product or service listing on an e-commerce platform.

17. The system of claim 14, wherein identifying the set of one or more images that are different from the input image comprises:
identifying product listings, wherein each of the set of one or more images represents one or more of the product listings.

18. The system of claim 14, wherein the first encoder and the second encoder are autoencoders.

19. The system of claim 14, wherein identifying the set of one or more images that are different from the input image comprises:
performing one or more operations of an approximate nearest neighbor (ANN) algorithm.

20. One or more computer storage media encoded with instructions that, when executed by one or more computers, cause the one or more computers to perform operations comprising:
generating a first embedding that represents an input image using a first encoder, wherein a dimension of the first embedding matches a first dimension;
generating, using the first embedding, a second embedding that represents (i) the input image and (ii) a modification to the input image, wherein a dimension of the second embedding matches the first dimension;
generating, using the second embedding, a third embedding that represents (i) the input image and (ii) the modification to the input image using a second encoder; and
identifying, using the third embedding, a set of one or more images that are different from the input image.
